(19) United States
(12) Patent Application Publication
(10) Pub. No.: US 2007/0114742 A1
(43) Pub. Date: May 24, 2007

(54) Motorized carts for stepping structures

(76) Inventors: Roger A. Gilbert, Murrieta, CA (US); Donald W. Werno, Corona, CA (US)

Correspondence Address: DONALD W. WERNO;Suite 115, 540 North Golden Circle Drive, Santa Ana, CA, 92705-3914, US

(21) Appl. No.: 11/496,657

(22) Filed: Jul. 31, 2006

Related U.S. Application Data
(60) Provisional application No. 60/703,589, filed on Jul. 29, 2005.
(60) Provisional application No. 60/784,669, filed on Mar. 22, 2006.

(51) Int. Cl. B62B 5/00

(52) U.S. Cl. 280/79.11

(57) ABSTRACT

Motorized carts for stepping structures are generally discussed herein with particular discussions on motorized carts for use with step ladders and scaffolding structures having wired or wireless controllers for maneuvering the carts. In accordance with aspects of the present invention, differential motor drive steering is incorporated to drive the cart forward, backward, and rotate. The differential motor drive includes a handheld controller and one or more DC drive motors. Mechanical connectors are incorporated to secure a stepping structure to the cart.

### CROSS-REFERENCE TO RELATED APPLICATIONS

This is an ordinary application of Provisional Application Ser. Nos. 60/703,589, filed Jul. 29, 2005, and 60/784,669, filed Mar. 22, 2006, both entitled “Motorized Carts for Stepping Structures”, their contents are expressly incorporated herein by reference as if set forth in full.

### FIELD OF ART

Motorized carts for stepping structures are generally discussed herein with particular discussions on motorized carts for use with step ladders and scaffolding structures having wired or wireless controllers for maneuvering the carts.

### BACKGROUND

Step ladders and scaffolding structures are well known in the art for use to access elevated points or locations not readily accessible by vertically challenged individuals. For simplicity of discussion unless the context indicates otherwise, only a step ladder will hereinafter be referred to although a scaffolding structure may equally apply.

When painting a house, hanging Christmas lights, changing a light bulb, hanging wallpaper, or mounting a ceiling fan, a step ladder is an indispensable device for performing the desired task, for obvious reason. However, a step ladder has its limitations when it comes to performing projects that require access over a wide elevated area, such as masking wall corners for painting a room or hanging crown molding. To perform such a project, the individual must climb on the ladder, perform the needed task, climb down the ladder, move the ladder, climb up the ladder, continue the needed task, climb down the ladder, move the ladder, and so forth until the entire project is completed. Not surprisingly, a simple project will often take longer and requires more efforts than first contemplated.

A greater concern than lost time and inefficiency is safety concern. Each time an individual climbs up and down a ladder he increases his chance of falling off the ladder. The odds are further increased when performing a project that requires access over a wide elevated area. In those instances, the individual will tend to overextend or stretch to reach a particular work area while on the ladder to perform the needed task. This ill-advised plan is intended to minimize the number of times he has to climb up and down to reposition the ladder. “Walking a ladder” is also common by hopping while on the ladder to move the ladder without having to dismount the ladder. The worker will thus expose himself to greater safety risks not just from mounting and dismounting the ladder, but also from misuse of the ladder.

Erecting scaffolding for an entire work area or using a motorized scissor lift to perform a project will minimize safety hazards. However, that solution is not always practical or cost effective. Accordingly, there is a need for an affordable motorized cart for a step structure, such as a step ladder or a scaffolding structure, capable of maneuvering while supporting both the step structure and the user.

### SUMMARY

The present invention may be implemented by providing a motorized stepping cart for use with a step structure having a first stepping member and a second stepping member positioned higher than the first stepping member, the motorized stepping cart comprising a frame comprising a first side, a second side; a plurality of wheels coupled to the frame including at least two wheels with each of the at least two wheels connected to a drive assembly comprising a motor and a gear train; a first attachment member positioned adjacent the first side and a second attachment member positioned adjacent the second side for attaching to a first side and a second side of a step structure; a hand operated control device in electrical communication with the two motors; a power source in electrical communication with the two motors; and wherein the two motors are configured to rotate concurrently at different rotational speed. The term “couple” is intended to mean attachment, connection, or placement of one body to another body either directly or indirectly using another body or structure.

In yet other aspects of the present invention, there is provided a motorized stepping cart for use with a step structure having a first stepping member and a second stepping member positioned higher than the first stepping member, the motorized stepping cart comprising a frame comprising a first side, a second side, and two longitudinal extending members parallel to one another; two rotatable casters coupled to the frame adjacent the first side and two rear wheels with each of the rear wheels connected to a motor coupled to the frame adjacent the second side, the two motors are configured to rotate in a direction opposite to one another; a hand operated control device in electrical communication with the two motors; and a DC power source in electrical communication with the two motors.

The present invention also comprises a method of using a motorized stepping cart comprising: placing a step structure onto the motorized stepping cart and securing the step structure to the cart, the cart comprising: a frame comprising a plurality wheels having at least two wheels connected to a motor and a gear train; a power source connected to the two motors; and a hand operated control device in electrical communication with the two motors; manipulating the hand operated control device; and rotating the two motors so that one motor rotates at a first speed and the other motor rotates at a second speed.

In still yet another aspect of the present invention, there is provided a combination motorized stepping cart and a step structure comprising: a cart body comprising a plurality of wheels, at least two motors in rotational communication with at least some of the plurality of wheels, a controller for operatively controlling the at least two motors, and a plurality of attachment devices; a step structure attached to the cart body using at least some of the plurality of attachment devices; and wherein at least two motors are capable of producing different rotational speed for at least some of the plurality of wheels.

In yet another aspect of the present invention, a motorized stepping cart for use with a step structure is provided comprising a frame comprising a plurality of wheels coupled to the frame including at least two wheels with each of the wheels connected to a drive assembly comprising a motor and a gear train; a tow hitch mechanically coupled to the frame; a hand operated control device in electrical communication with the two motors; a power source in electrical communication with the two motors; and wherein the two motors are capable of rotating concurrently at different rotational speed.

Yet, the invention may be practiced by providing a motorized stepping cart for use with a step structure comprising a frame comprising a first side and a second side; two rotatable casters coupled to the frame adjacent the first side and two rear wheels with each of the rear wheels connected to a motor coupled to the frame adjacent the second side, the two motors are configured to rotate in a direction opposite to one another; a hand operated control device in electrical communication with the two motors; and a DC power source in electrical communication with the two motors, wherein the frame is configured to accept a stepping structure comprising a first frame foot spaced apart from a second frame foot.

Other aspects of the present invention include a combination motorized stepping cart and a step structure comprising: a cart body comprising a plurality of wheels, at least two motors in rotational communication with at least some of the plurality of wheels, a controller for operatively controlling the at least two motors, and a plurality of attachment devices; a step structure attached to the cart body using at least some of the plurality of attachment devices; and wherein at least two motors are capable of producing different rotational speed for at least some of the plurality of wheels.

In yet other aspects of the present invention, the first and second attachment members include adjustment devices for coupling to the legs of a ladder or a scaffolding structure.

The present invention may also be practiced by incorporating radio frequency technology to communicate between the handheld device and the motors.

Still yet, the present invention may be practiced by incorporating a rechargeable batteries for providing the motors with DC power.

The motorized cart may be equipped with 4-wheel drive, 6-wheel drive, and may have wheels that are sprockets for use with a chain.

The drive transmission may be disengaged so that the motorized cart may be pushed manually.

The motorized cart may be used independent of the step structure.

Other aspects and features of the motorized cart provided herein may be better appreciated as the same become better understood with reference to the specification, claims, and appended drawings.

### BRIEF DESCRIPTION OF THE DRAWINGS

The appended drawings include:

FIG. 1, a semi-schematic perspective view of a motorized stepping cart provided in accordance with aspects of the present invention;

FIG. 2, a semi-schematic side view of the motorized stepping cart of FIG. 1;

FIG. 3, a semi-schematic top view of the motorized stepping cart of FIG. 1;

FIG. 4, a semi-schematic top view of an attachment device provided in accordance with aspects of the present invention;

FIG. 5, a semi-schematic perspective view of the attachment device of claim 4;

FIG. 6, a semi-schematic side view of a step structure mounted to a motorized stepping cart provided in accordance with aspects of the present invention;

FIG. 7, a semi-schematic perspective view of a cart frame provided in accordance with aspects of the present invention;

FIG. 8, a semi-schematic block diagram of a drive system provided in accordance with aspects of the present invention; and

FIG. 9, a semi-schematic block flow diagram of a drive logic provided in accordance with aspects of the present invention.

### DETAILED DESCRIPTION

The detailed description set forth below in connection with the appended drawings is intended as a description of the presently preferred embodiments of motorized carts for stepping structures (hereinafter “motorized stepping cart(s)” or “cart(s)”) provided in accordance with aspects of the present invention and is not intended to represent the only forms in which the present invention may be constructed or utilized. The description sets forth the features and the steps for constructing and using the motorized stepping carts of the present invention in connection with the illustrated embodiments. It is to be understood, however, that the same or equivalent functions and structures may be accomplished by different embodiments also intended to be encompassed within the spirit and scope of the invention. As denoted elsewhere herein, like element numbers are intended to indicate like or similar elements or features.

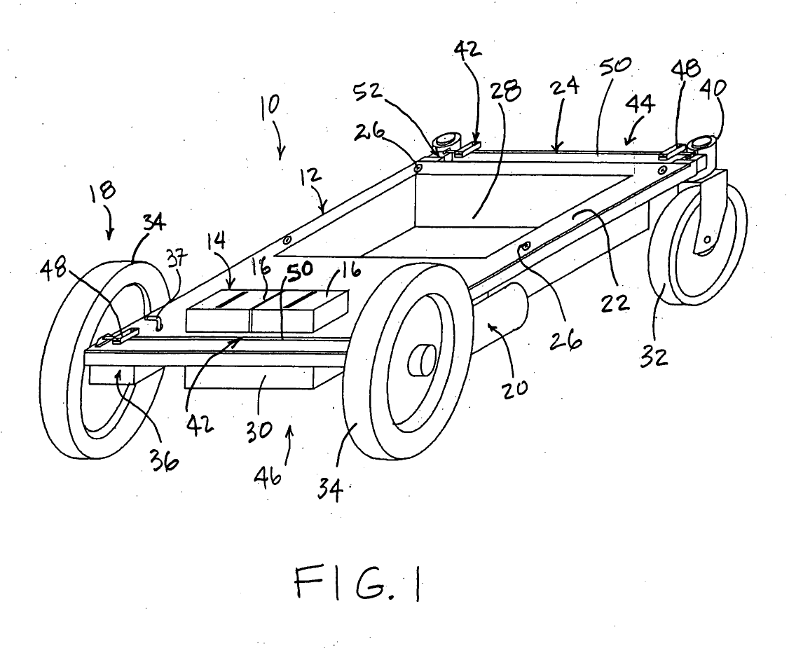

Referring now to FIG. 1, there is shown an exemplary motorized stepping cart provided in accordance with aspects of the present invention, which is generally designated 10. In one exemplary embodiment, the cart 10 comprises a cart body 12 and a drive train 14 comprising a wired or wireless hand controller (not shown), one or more power sources 16, a plurality of wheels 18, one or more motors 20, and electronic circuits (not shown) for providing a closed loop control between the one or more motors 20 and the handheld or hand operated controller, as further discussed below.

In one exemplary embodiment, the cart body 12 comprises a cart cover or housing 22 coupled to a chassis or frame 24. In one particular embodiment, the cart cover 22 is made from low pressure vacuum formed thermoplastic liner fastened to a steel frame 24 using one or more fasteners, screws, or rivets 26. The thermoplastic material may have a rigid or semi-rigid characteristic and may comprise PVC, polycarbonate, or ABS. Alternatively, a metal-based housing cover or a combination metal-based and plastic housing cover may be used. Appropriate number of ribs and rib placements may be necessary to provide adequate structural integrity for supporting various tools or components, as further discussed below. Alternatively or in addition thereto, fiberglass reinforcement, carbon fiber reinforcement, or plastic composites may be used to enhance the structural integrity of the cart cover 22.

In one exemplary embodiment, a main trough 28 may be incorporated in the cart cover 22 for carrying tools, paint, or any other desired goods or devices. The trough 28 may include any number of configurations, including a square, a rectangle, an oval, or any other shape. A secondary trough 30 may also be incorporated for accommodating the one or more power sources 16. Although not shown, a trough cover may be incorporated for either or both the main trough 28 and the secondary trough 30. The trough cover, if incorporated, would seal or enclose the power source and would cover the main trough to provide a larger generally flat surface area for use as a workbench or a cargo space. The trough cover may be hinged and latched to the cart cover to enclose the trough opening and may comprise any prior art attachment means, such as a spring loaded pin, a detent engagement, hook and loop configuration, etc. Colors and design indicia, including using electroluminescent technology, may be incorporated to provide a custom look cart cover 22. In an alternative embodiment, the main trough 28 may be eliminated and a flat deck used as a cargo space and loading deck. Still alternatively or in addition thereto, an external crate, bucket, or box may be mounted on the cart cover for holding tools and the like.

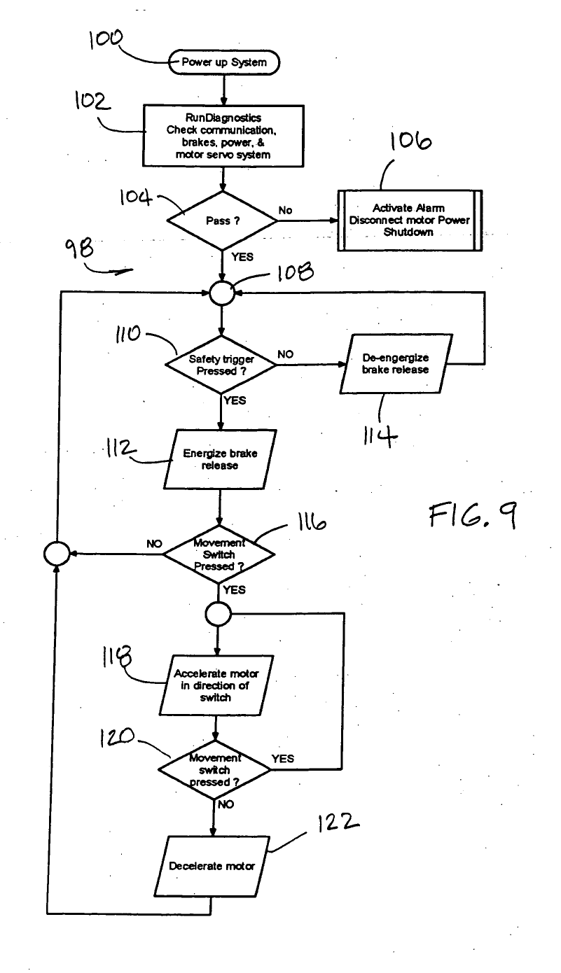

In one exemplary embodiment, the drive train 14 comprises a DC drive or servo motor drive system. The drive train 14 comprises two front caster wheels 32, two differentially driven rear wheels 34 each connected to a gear drive train or drive transmission 36 and a servo motor 20. The drive train 14 is powered and controlled by well-known servo motor technology using PWM technology. An exemplary application of PWM technology in everyday use is with wheelchairs for the walking impaired. In a preferred embodiment, the drive train 14 comprises a closed-loop control system in which a handheld controller (FIG. 8), which may be a wired or wireless joystick servo controller, communicates to a motor mounted servo motor controller to control the motor 20 output. As further discussed below, the closed-loop control includes system diagnostics for checking the drive train status before allowing the two motors to provide an output to the drive transmission. Exemplary motors include motors made by Motor Technologies, model No. 275a102q, Quikie model No. 499283, and Advanced DC model No. 140-07-4001. The motors preferably include DC permanent magnet (elnaco, rare earth, or ceramic), incorporating a spring loaded electrically releasable brake, with a duty cycle of about no less than 50% at rated current, which is dependent on the particular application of the motors. The locked motor current is preferably not to exceed 60 amp and the motor no load speed is rated at about 3,500 rpm. Exemplary motor drive transmission or right angle gear box train 36 includes those made by Quikie model No. P-222SE, National model Nos. NPC-31250 and NPC-60522. Preferably, a transmission release lever 37 is incorporated to uncouple the wheels from the drive transmission for manual operation of the cart. Exemplary handheld controller includes Dynamic model No. DH40UEH3, Maurey model No. JS3146-S, and Allied model No. 522-0082. Alternatively, a joystick grip with a side trigger and a thumb motion controller on an end of the joystick is used as a hand operated control device. In an alternative embodiment, an AC to DC converter may be incorporated so that household power may be used to drive the motors. In an alternative embodiment, DC motors may be used rather than servo motors. The control scheme and the controller logic may require modification to operate with standard DC motors.

In one exemplary embodiment, the one or more power source 16 comprises two independent batteries. In one exemplary embodiment, a DC to AC inverter is incorporated to convert the battery DC power to AC power for use to operate power tools, to operate a compressor, as a battery charger for portable hand tools, and the like. Any standard deep cycle automotive sealed lead acid battery from any automotive parts store may be used to power the motors. Deep cycle rated batteries may also include those commonly used in the ocean or marine industry. In one exemplary embodiment, solar energy may be used to recharge the batteries. For example, one or more solar panels may be incorporated along with electronics for converting solar energy into electrical energy to recharge the batteries.

In one exemplary embodiment, the rear wheels 34 and the front wheels 32 both incorporate hospital grade solid rubber tires to minimize markings when used indoors. However, other pressure-less rubber tires or pressurized tires (such as ATV tires) may be used without deviating from the spirit and scope of the present invention. In one exemplary embodiment, the front caster wheels 32 are each individually coupled to a yoke 40 connected to the chassis 24. The spindle sleeve in which the front caster rotates in may include either a sleeve bearing or a roller bearing connection.

In one exemplary embodiment, a width adjuster 42 is incorporated at the first end 44 and the second end 46 of the cart 10. Each width adjuster 42 comprises a first structure 48 slidably coupled relative to a second structure 50. In one aspect of the present invention, the first structure 48 comprises an attachment bucket and the second structure 50 comprises a stationary shaft. In a preferred embodiment, each width adjuster 42 comprises a single stationary rod and two attachment buckets. One or both attachment buckets 48 may be adjustable relative to the stationary rod 50 so that the spacing between the two buckets is sufficient to accommodate the width of a particular ladder.

In one exemplary embodiment, a length adjuster 52 is incorporated to adjust for the length or span of a ladder. In one aspect of the present invention, the length adjuster 52 comprises a tube telescopically coupled to a corresponding tube for adjusting the amount of overlap between the two. The amount of overlap will regulate or control the length of the cart. A set wing nut or screw may be used to fix the overlapped tubes once the proper length is set. Although the phrase “tube” is used, the frame may be made from a number of configurations, including a round pipe, a square shaped pipe, a rectangular shaped pipe, other shaped pipes, and any combination thereof.

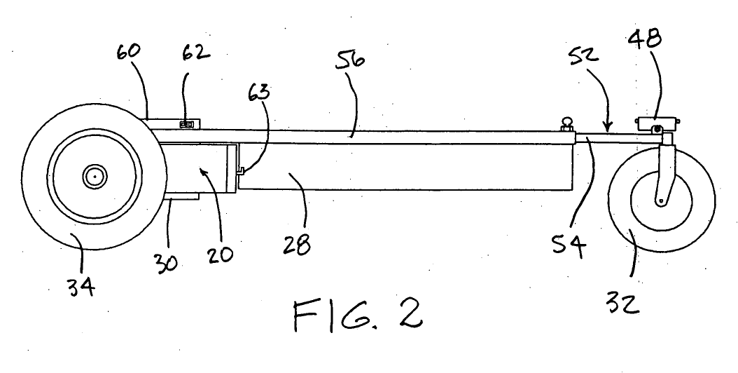

FIG. 2 is a semi-schematic side view of the motorized stepping cart 10 of FIG. 1. As shown, the length adjuster 52 comprises two extension members 54 (one superimposed over the other) telescopically coupled to two corresponding longitudinally extending members 56 forming part of the chassis 24, as further discussed below. A wing nut 58 is shown secured to the frame to fix the two longitudinally extending members 54, 56 relative to one another. Also shown in FIG. 2 is a rear trough cover 60. The rear trough cover 60 includes a movable latch 62 for locking or releasing the cover 60 from the secondary trough 30.

Although the motorized stepping cart 10 may embody a number of sizes and dimensions, in a preferred embodiment, the cart 10 comprises a generally rectangular structure having a 30 to 45-inch adjustable width wheel base and a 40 to 60-inch adjustable length wheel base with a weight distribution of approximately 60/40 rear/front when a ladder is mounted thereto with a user standing thereon. A motor brake switch 63 is shown on the motor 20 for engaging or disengaging the spring-loaded brake to prevent intended or accidental movement of the cart.

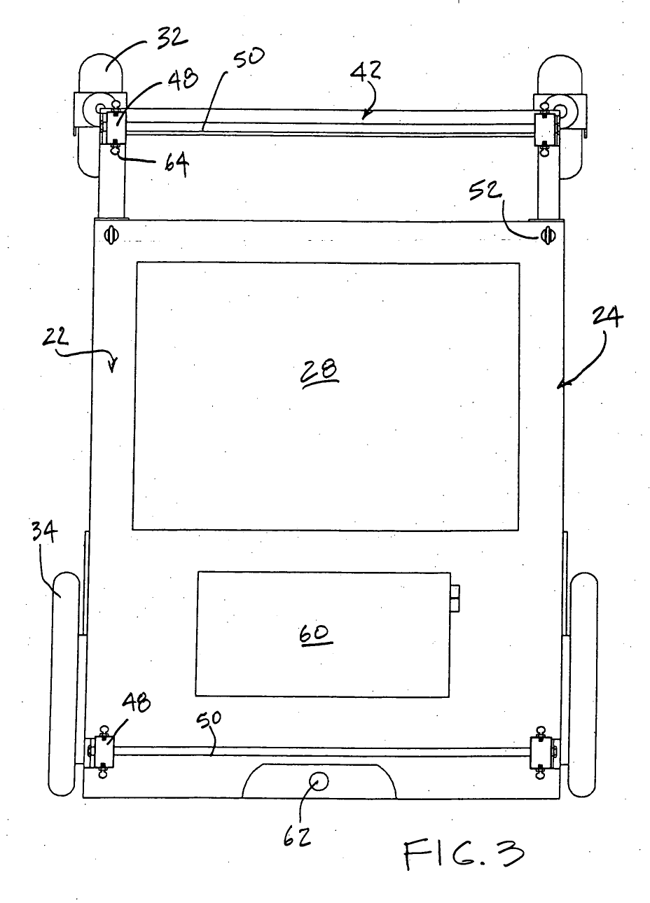

FIG. 3 is a semi-schematic top view of the cart 10 of FIG. 1. In one exemplary embodiment, a tow hitch 62 is incorporated. The tow hitch may be used to tow a number of devices, including a pull cart, a wagon, a wheeled compressor, a wheeled generator, and other wheeled devices. Although the cart 10 is motorized and controllably maneuverable using a handheld controller, as further discussed below, in one exemplary embodiment, the motor transmissions or gear train may be disengaged and the cart manually push-able from location to location when not using the motor drive or for quick movement across a longer distance where pushing is quicker than using the motor drive to move the cart. In one exemplary embodiment, mud, spackel, plaster, oil, paint, or other fluidized material is stored in a bucket or drum and the drum positioned in the cart or wagon and pumped, via a hydraulic or reciprocating pump, to a worker located at the top of a stepping structure. In another embodiment, the wagon or the motorized cart may be equipped with shafted wire spools for feeding wires to a user.

In one exemplary embodiment, the first structure 48 of the width adjuster 42 each comprises an attachment bucket comprising an adjustment screw 64. In a preferred embodiment, two diametrically opposed adjustment screws 64 are incorporated on each attachment bucket 48 for adjusting and separately engaging a ladder leg. More preferably, two spring loaded pins are incorporated on each attachment bucket for separately engaging a ladder leg, as further discussed below. Still more preferably, 4 spring loaded pins 64 are incorporated to allow for a 4-way adjustment. Each slidable first structure 48 is preferably mounted to the stationary shaft using Reeves bearing. The Reeves bearing allows the structure 48 to slide while concurrently resists non-intended sliding motion. In other words, by using Reeves bearings, the width adjuster 42 may be adjusted without having to independently lock the two attachment buckets relative to the stationary shaft 50 once a desired width is established. In a less preferred embodiment, the step structure may be more firmly attached to the cart using more complicated lock mechanism that requires more than easy hand turn motion to engage and disengage the step structure from the cart. Obviously, and even less preferably, the step structure may be permanently attached to the cart using welding or other attachment means not readily accessible to the user for disassembling. In the less preferred embodiment, the cart may be sized to accommodate a particular step structure dimension without incorporating a width adjustment mechanism or a length adjustment mechanism.

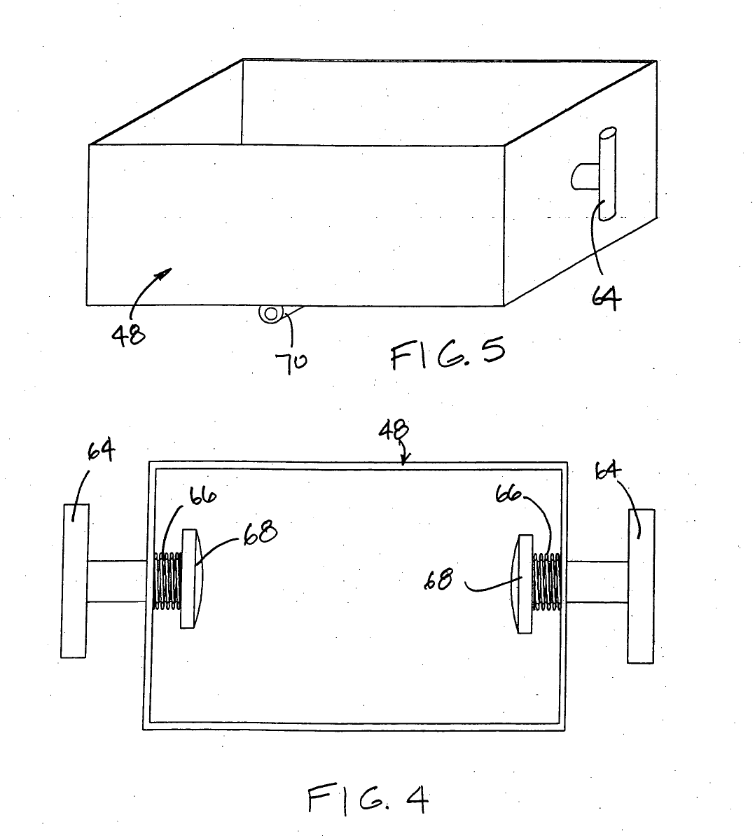

FIG. 4 is a top view of an adjustment bucket provided in accordance with aspects of the present invention. In one exemplary embodiment, two spring-loaded lock pins 64 are incorporated, each comprising a helical coil spring 66 and an end cap 68. Alternatively, the first structure 48 may comprise a combination thread adjustment for roughly adjusting the gap between the two end caps 68 and springs for final adjustment. Still alternatively, other types of attachment devices may be used to secure a ladder onto the cart 10. As examples, a C-type clamp may be used to clamp onto the ladder legs, a J-bolt hook-type device may be used to hook onto one of the ladder rungs, a strap may be used to strap the ladder legs with the cart, and Bungee cords may also be used instead of or in addition to a strap. Still alternatively, the ladder may be fitted with a custom designed attachment member on each of the four legs for attaching to corresponding mating members on the cart. As an example, each leg may be equipped with a slip on shoe and the shoe mechanically latched with a mating member on the cart 10. The slip on shoes may comprise a collar that slides on the end of one of the ladder legs and has a wing or a flange configured to lock or mate with a clamp, a detent, a groove, a spring-loaded device, etc. In short, a number of attachment devices are contemplated for securing the ladder to the cart.

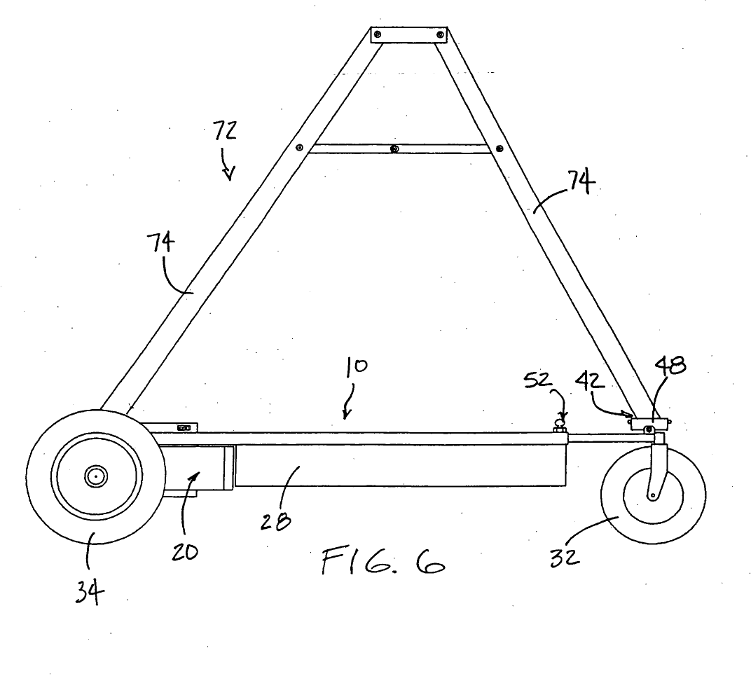

FIG. 5 is a semi-schematic perspective view of the adjustment bucket of FIG. 4. An enclosed guide member 70 is incorporated on the underside of the bucket for coupling to the stationary shaft member 50. The ladder retaining buckets 48 are slid onto the shaft before two end plates are placed over the shaft and a retaining nut is placed on the end of each end plate to lock the shaft in place.

FIG. 6 is a semi-schematic side view of the cart of FIG. 1 with an A-frame step ladder 72 mounted thereon. The A-frame ladder 72 comprises four legs 74 with each leg in mechanical communication with a first structure 48 of the width adjuster 42. As is readily apparent to a person of ordinary skills in the art, the length adjuster 52 and the width adjuster 42 may need adjustment in order to accommodate the four ladder legs.

The ladder 72 is preferably of a highly functional type. For example, the ladder should be adjustable, may extend or vary telescopically, may convert to a U-shape scaffold, and may include ladder rungs on both sides of the A-frame. Exemplary highly functional ladders include the Series 7800, Series C370, Series E7400, Series M1, and Series MT ladders, all made by Werner Company, having a place of business in Greenville, Pa. Other ladders include ladders from the Little Giant Ladder Systems, including the Type 1, Type 1A, Type 1AA, Safety Step, Ultra Step, Fiberglass 1A, and Skyscraper ladders. Still alternatively, an extension ladder may be used. If used, means for supporting the extension ladder may be required. In one exemplary embodiment, a vertical bracket or frame may attach to the chassis 24 and the extension ladder rests thereon for support. Still yet alternatively, a scaffolding structure may be used instead of the A-frame ladder 72. Obviously, appropriate attachment devices should be incorporated to secure the scaffold legs to the cart 10. In one exemplary embodiment, the ladder 72 is provided with accessories, such as a work platform that attaches to the ladder, a tool caddy for hanging or storing tools, a conduit holder, and a paint bucket hanger. Other exemplary accessory items include those identified as “accessories” on the Werner Company website, at www.wernerladder.com.

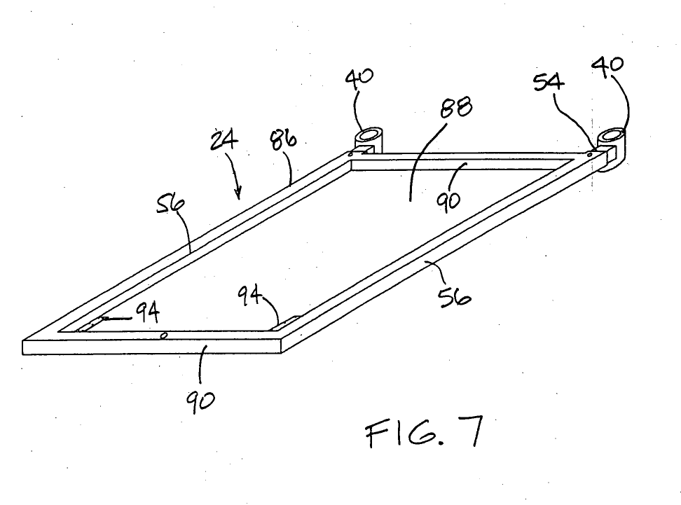

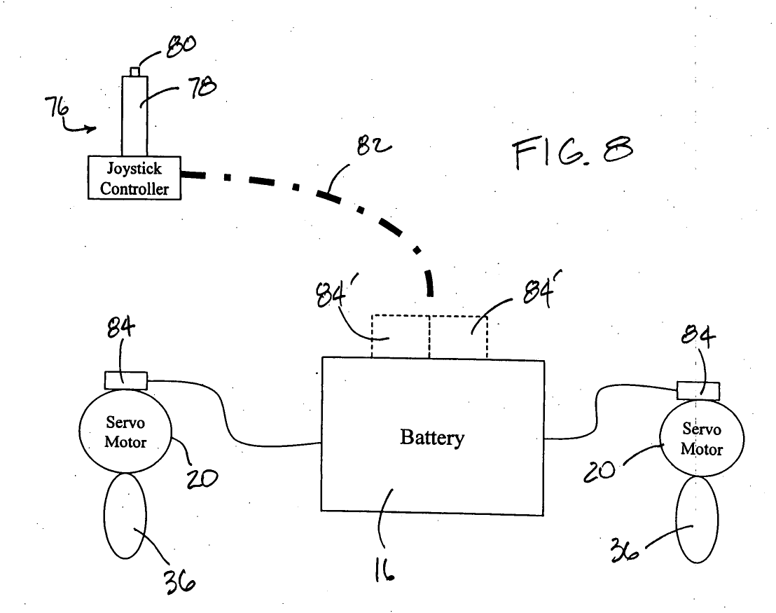

Referring now to FIG. 7, a semi-schematic perspective view of the chassis 24 is shown. In one exemplary embodiment, the chassis 24 comprises a rigid frame 86 defining a central cavity 88. In accordance with one aspect of the present invention, the rigid frame 86 comprises a plurality of welded rectangular tubing or piping members 56, 90 having sufficient thickness or gauge for structurally supporting at least the weight of a user, the step structure, and various cart components or tools placed or mounted thereon. In a preferred embodiment, the frame is configured to support at least about 300 lbs to in excess of about 700 lbs. However, the cart 10 may be sized for heavier or lighter duty depending on the intended application. As previously discussed, the two side longitudinal extending members 56 are hollow and are adapted to receive the two extension members 54 forming part of a length adjuster 52. Each extension member 54 comprises a yoke 40 for receiving a caster pin. Two mounting flanges 94 are incorporated on the chassis 24, each for mounting the combination drive transmission 36 and servo motor 20, i.e., drive assembly.

FIG. 8 is a semi-schematic block diagram of part of the drive train or system 14 provided in accordance with aspects of the present invention. In one exemplary embodiment, the drive system 14 comprises a hand controller 76 for operatively controlling the motion of the cart 10. The hand-operated controller 76 may comprise a joystick controller 78 for directionally controlling the cart movement and a trigger 80 for energizing the drive system. The hand operated controller 76 may comprise a hard-wired controller using a cable 82 or a wireless controller, using radio frequency, IR, or laser, to wirelessly communicate to the left and the right servo controllers 84. In one exemplary embodiment, the servo controllers 84 are each integrated with a respective motor 20. In an alternative embodiment, a separate servo controller 84′, shown as dot-dashed lines, may be mounted on the cart in the secondary trough 30. More preferably, two separate servo controllers are used to separately control each of the two servo motors 20. As is well known in the art, a controller may be a microprocessor for processing signals between the joystick 76 and the two motors 20.

Pushing or pulling on the trigger 80 on the hand operated controller 76 and pointing the joystick 78 to a desired direction will mobilize the cart 10. By pulling on the trigger 80 and pointing the joystick, signals or commands are sent to the servo controller 84 to tell the two motors 20 the speed at which to turn and the turning direction. The two motors can concurrently operate at different speeds and can rotate in different directions. The motor outputs are in turn coupled to the drive transmission or gear train 36, which in turn are connected to the rear wheels 34 and cause the rear wheels to turn. Thus, unlike a conventional mechanical steering mechanism, which uses a steering column, linkages and/or universal joints, the cart 10 provided herein moves by manipulating a hand operated control device 76 to produce electrical signals that in turn will determine the speed of rotation and direction of rotation of the two motors, and hence the rear wheels, to then turn and move the cart 10 in a desired direction and position. Advantageously and among other things, the turning radius of the cart 10 as provided herein is much smaller as compared to a similar sized cart having a conventional mechanical steering mechanism.

Turning now to FIG. 9, a semi-schematic block flow diagram of a drive logic 98 provided in accordance with aspects of the present invention is shown. In one exemplary embodiment, pulling or pushing the trigger button 80 on the handheld controller 76 will initialize the cart, i.e., power up the system 100. The controller 84 then runs diagnostics 102 of the drive train by performing tasks such as checking communication between the motors and the controller and between the controller and the handheld device. If the test is successful, the programmed logic allows the cart to proceed by waiting for a follow up command 108. If the test fails, an alarm is activated 106 and the power to the motors is disconnected. In one exemplary embodiment, a failure readout code is presented on a display screen to report the diagnosed error. In a preferred embodiment, a help menu is also displayed to provide the user with possible solutions. If incorporated, the display menu may be incorporated in the secondary trough next to the power source. A chart of the error codes along with recommended maintenance or repair tips may be provided on a backside of the trough cover, such as on a printed sticker affixed to the cover.

If the trigger is still pressed 110, the brakes will release 112 and the cart will be ready to move or advance. If the trigger is released or let go, the brakes will de-energize 114 and the spring loaded brakes will turn on. If the user moves the joystick 116 to move the cart, signals are sent 118 to the motors to either rotate in the same direction and at the same speed (to go forward or backward), to rotate in the same direction but at different speed (to turn left or right), or to rotate differently and at the same or different speed to make a sharp turn about a small radius or a larger turn about a larger radius, such as turning around. If the joystick, and more particularly the trigger, is subsequently released 120, the motors will decelerate 122 and the system will revert to a waiting loop 108, waiting for a command. The three microprocessors, one each on the handheld controller and the two servo controllers, are preferably in constant communication, in a macro sense as information or commands travel series. If for any reason the system does not have the required communication between the handheld controller and the two servo motor controllers, the cart will not move.

Commands from the handheld controller 76 to the two motor controllers 84 thus comprise a stop command, a forward command, a reverse command, an acceleration command, a deceleration command, and a status command. The motors also initiate communication with the handheld controller by sending a status command. The handheld controller also receives command from a user through the trigger and the joystick. Preferably, the handheld controller ignores the joystick if the trigger is not pressed. This configuration would eliminate incidental joystick movement during normal use of the cart. Releasing the trigger during intended movement of the cart represents a stop command from the handheld controller to the motor controllers.

In one exemplary embodiment, the hand controller 76 and the servo controller 84 or 84′ are equipped with coded security features for discriminately communicating with one another in the presence of other hand controllers and servo controllers without cross-talking with either the other hand controllers and/or other servo controllers. This technology is well known in the remote controlled toy car industry.

In another embodiment, the cart 10 is equipped with a mechanical lock that powers the servo controller and/or the hand controller on before the two can communicate with one another. The mechanical lock and key combination provides a deterrent against theft.

In an alternative embodiment, the cart 10 is equipped with one or more outriggers for added width to height ratio, and hence stability. An outrigger may be configured to extend from each side of the four sides of the cart. The outriggers may each incorporate a wheel or a pivotable caster or alternatively have an extension that is slightly spaced apart from the ground to permit some tilting of the cart before being delimited by the extension from tipping. In an alternative embodiment, only one outrigger is incorporated. The one outrigger would be ideally positioned on a side of the cart away from a walled structure or other structure, as the walled structure or the other structure already provides a safety barrier against tipping. In another embodiment, the outrigger(s) is equipped with a gear drive and a motor for electronically extending and retracting the outrigger. The extending and retracting mechanism should be programmed to be controllable by the hand controller.

In yet another alternative embodiment, a hook or a loop is incorporated with the cart frame. The hook or loop may be used to chain or lock the cart to a rigid structure for security purposes. For example, a chain may be passed through the loop and then around a generally permanent structure to then chain the cart to the structure.

In still yet another alternative embodiment, the frame and the various components used to manufacture the cart are configured to be waterproof and/or rust proof. For example, the motors may be rated for outdoor use and the frame coated with a rust proof coating.

In yet another alternative embodiment, a serial number is tack-weld or embedded onto the cart for tracking the cart and/or for security purposes. The motorized cart may also include a removable and swivel-able chair. The chair, which may be attached to the cart using attaching means, such as fasteners, brackets, adjustable tracks, rack and pinions, and/or gears, for allowing a user to use the cart like a wheel-chair, a drive-assist device, or a trolley for moving along the floor to work on low hanging items, such as a series of electrical outlets. When used as a drive-assist device, the cart resembles a motorized cart made by Pride Mobility, Golden Technologies, or Pacesaver, except that cart provided in accordance with aspects of the present invention is equipped with a wireless controller and with independent servo motor drives. The wireless controller allows a companion or a caregiver to control the cart on behalf of a person situated on the cart.

In another embodiment, the cart is equipped with a sound generator for emitting an audible signal when backing up, when illegally moved or transported (i.e., like a car alarm), and for sounding a horn. The cart is also preferably equipped with lighting capabilities, either as headlights or rotatable lights/spotlights.

In yet another embodiment, removable fencing or railings may be incorporated for forming a storage cavity. For example, grocery bags, gardening tools, and other items may be loaded onto the cart and transported while the railings provide a barrier against falling or being displaced from the cart.

In still yet another alternative embodiment, the cart is equipped with speed control for limiting the maximum travel speed of the cart. Preferably, the cart is also equipped with an acceleration control for minimizing jerking when the cart is initiated/started.

Although limited embodiments of the motorized stepping carts and their components have been specifically described and illustrated herein, many modifications and variations will be apparent to those skilled in the art. For example, the chassis may be round or other than rectangular shape, a cart cover does not have be incorporated and a separate rigid frame to hold the power source and/or tools, the cart may have 4-wheel drive, 6-wheel drive, the plurality of wheels may be sprockets and a chain instead of rubber tires, the cart may be used indoor or outdoor, is made to be weather resistant, etc. Although batteries and household electricity with a AC to DC converter are provided as examples of the power source, conceivably a generator, an internal combustion engine, pneumatic motors, and fuel cells may also be used. The cart may also be used without the ladder for carrying tools and equipment, taking out trash, relocating furniture, taking in groceries, etc. Other changes may include incorporating a drive train release mechanism to release or uncouple the motor and/or gear train from the plurality of wheels to allow for manual operation/push-ability of the cart and/or incorporating a break mechanism for de-energizing the motors from the power source so that even if the hand operated controller is manipulated, the cart would not move. Accordingly, it is to be understood that the motorized stepping carts and their components constructed according to principles of this invention may be embodied other than as specifically described herein. The invention is also defined in the following claims.

What is claimed is:

1. A motorized stepping cart for use with a step structure having a first stepping member and a second stepping member positioned higher than the first stepping member, the motorized stepping cart comprising a frame comprising a first side, a second side; a plurality of wheels coupled to the frame including at least two wheels with each of the at least two wheels connected to a drive assembly comprising a motor and a gear train; a first attachment member positioned adjacent the first side and a second attachment member positioned adjacent the second side for attaching to a first side and a second side of a step structure; a hand operated control device in electrical communication with the two motors; a power source in electrical communication with the two motors; and wherein the two motors are configured to rotate concurrently at different rotational speed.

2. The motorized stepping cart of claim 1, further comprising a tow hitch mounted to the frame.

3. The motorized stepping cart of claim 1, further comprising a motor controller for controlling the two motors.

4. The motorized stepping cart of claim 3, wherein the hand control device is configured to wirelessly communicate with the motor controller.

5. The motorized stepping cart of claim 1, further comprising a step ladder coupled to the frame.

6. The motorized stepping cart of claim 1, further comprising a scaffold structure coupled to the frame.

7. The motorized stepping cart of claim 1, further comprising a storage space positioned between the first side and the second side.

8. A motorized stepping cart for use with a step structure having a first stepping member and a second stepping member positioned higher than the first stepping member, the motorized stepping cart comprising a frame comprising a first side, a second side, and two longitudinal extending members parallel to one another; two rotatable casters coupled to the frame adjacent the first side and two rear wheels with each of the rear wheels connected to a motor coupled to the frame adjacent the second side, the two motors are configured to rotate in a direction opposite to one another; a hand operated control device in electrical communication with the two motors; and a DC power source in electrical communication with the two motors.

9. The motorized stepping cart of claim 8, further comprising a seat coupled to the frame.

10. The motorized stepping cart of claim 8, further comprising a motor controller for controlling the two motors.

11. The motorized stepping cart of claim 10, wherein the hand operated control device is configured to wirelessly communicate with the motor controller.

12. The motorized stepping cart of claim 8, further comprising a A-frame step ladder coupled to the frame.

13. The motorized stepping cart of claim 8, wherein the hand operated control device comprises a joystick comprising a trigger.

14. The motorized stepping cart of claim 8, wherein the frame comprises a metal rectangular frame.

15. A motorized stepping cart for use with a step structure comprising a frame comprising a first side and a second side; two rotatable casters coupled to the frame adjacent the first side and two rear wheels with each of the rear wheels connected to a motor coupled to the frame adjacent the second side, the two motors are configured to rotate in a direction opposite to one another; a hand operated control device in electrical communication with the two motors; and a DC power source in electrical communication with the two motors, wherein the frame is configured to accept a stepping structure comprising a first frame foot spaced apart from a second frame foot.

16. The motorized stepping cart of claim 15, further comprising a DC power to AC power inverter.

17. The motorized stepping cart of claim 15, further comprising a scaffold structure coupled to the frame.

18. The motorized stepping cart of claim 15, further comprising a motor controller for controlling the two motors.

19. The motorized stepping cart of claim 15, further comprising a thermoplastic cart body coupled to the frame.

20. The motorized stepping cart of claim 15, further comprising a holding area for accommodating the DC power source.
